(19) United States
(12) Patent Application Publication
(10) Pub. No.: US 2007/0260982 A1
(43) Pub. Date: Nov. 8, 2007

(54) Runtime human-machine interface for process control having enhanced graphical views of detailed control information

(75) Inventors: Donald J. Wayland, Attleboro, MA (US); Anne E. Linscott, Plainville, MA (US); Thomas D. Sherrill, Upton, MA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Invensys Systems, Inc., Foxboro, MA (US)

(21) Appl. No.: 11/403,190

(22) Filed: Apr. 11, 2006

(51) Int. Cl. G06F 3/00

(52) U.S. Cl. 715/700

(57) ABSTRACT

An HMI application supporting interaction between an operator and runtime control processor information is described herein. The HMI application provides graphical user interface-driven functionality including, among other things supporting a horizontal hierarchical view selection menu. Furthermore, visual alarm indicators associated with the view selection menu guide an operator through each view selection level to a view showing an alarm's source. The horizontal view selection menu is traversable by both a graphical pointer and keyboard strokes (e.g., dynamically assigned function keys). Enhanced faceplate overlays provide access to detailed information from a control block such as alarm limits and tuning parameters. Such detailed information is accessed by first exposing a menu of detailed information, and thereafter rendering the detailed information within a work area of the faceplate separate from the menu from which the detailed information type is selected for the control block.

### FIELD OF THE INVENTION

The present invention generally relates to the field of programmable/configurable computerized control systems. More particularly, the invention concerns application programs including graphical human-machine interfaces for monitoring the status of and/or exercising supervisory control over continuous and/or discrete controlled processes. Such interfaces often provide multiple screens tied to data representing the status of the controlled processes.

### BACKGROUND

Industry increasingly depends upon highly automated data acquisition and control systems to ensure that industrial processes/operations run efficiently, safely and reliably while lowering overall costs. In such systems, data acquisition begins with sensors measuring current values/status of process variables representing the status/operation of an industrial process or operation. The measurements are communicated to programmed controllers and data collection/management systems. The data collection/management systems, generally including process databases and data processing routines, manage and maintain the measurement data. Such data management and maintenance includes further processing the data (e.g., filtering), storing the data, and distributing the data to a variety of client applications. Such client applications include both automated and manual supervisory control processes and display/monitor user interfaces.

Industrial process/operation measurements come in a wide variety of forms and are used by industrial process control systems to regulate a variety of operations, both with respect to continuous and discrete manufacturing processes. By way of example the measurements produced by a sensor/recorder include: a temperature, a pressure, a pH, a mass/volume flow of material, a number of bottles filled per hour, a tallied inventory of packages waiting in a shipping line, or a photograph of a room in a factory. Often, sophisticated automated process management and control hardware/software examine acquired process/operation measurement data, and respond by sending messages/signals to actuators/controllers that adjust the operation of at least a portion of the industrial process. However, the data produced by the sensors is also provided to human-machine interface (HMI) applications. The HMI applications support a variety of views that enable an operator to perform a number of supervisory tasks including: tailor the process (e.g., specify new set points) in response to varying external conditions (including costs of raw materials), detect an inefficient/non-optimal operating condition and/or impending equipment failure (alarm), and take remedial actions such as shut down a process or move equipment into and out of service as required.

Highly advanced HMI/process visualization systems exist today that are linked to data sources such as the above-described sensors and controllers. Such systems acquire and digest (e.g., filter) the process data described above. The digested process data in-turn drives a graphical display rendered by a human machine interface. Such data includes mode changes, events, and alarm messages rendered by process controllers in response to a variety of detected process conditions/circumstances.

One aspect of HMI applications is management of potentially hundreds of different supported views of controlled processes within a plant. In relatively small controlled processes, the amount of information provided and displayed on HMI screens is relatively small and is handled by a relatively small number of screens/views. However, many industrial processes are very complex. Such processes contain potentially include thousands of sensors and control elements (e.g., valve actuators) monitoring/controlling all aspects of a multi-stage process within an industrial plant. The number of screens/views required to present the relevant data to operators via the HMI application is potentially very large.

Known HMI applications utilize drop-down menus to provide access to the various screens for a particular control application. In one instance, the menu comprises a flat list of supported screens. Another known process control HMI organizes the supported screens as cascaded drop-down menus wherein menu entries represent a view and a link to potentially child views (identified as items within a cascade menu). Once a selection is made, the menu disappears and the selected screen is rendered. In yet other known methods for accessing views, child, parent, and left-right sibling view buttons are hard-coded onto each view. This method of providing hierarchically arranged views requires that the hierarchy be configured into each view in a visualization project.

Furthermore, process alarm messages are traditionally sent from plant control processors to alarm displays on workstations to notify operators of plant upsets. Generally, alarm messages are issued by control processors when a measured or calculated value is rendered outside a pre-configured range. The plant controller transmits the generated alarm to one or more operator workstations coupled to a separate (e.g., application) network. Once alarms requiring human intervention are received at a workstation, it is important that an operator be able to quickly identify the problem and, if needed, take remedial action.

Another challenge faced when providing a visualization interface for monitoring an industrial process is how to provide access to detailed information associated with particular control blocks—the greatest degree of detail. In known systems, details were simply restricted to specific critical pieces of information. Alternatively, an expanded set of details are provided by a full screen display. In yet other instances, a separate engineering tool provided the detailed information on the control block in a completely separate window.

### SUMMARY OF THE INVENTION

In accordance with the present invention, a human machine interface (HMI) executes a visualization project for a process control system. The visualization project includes a set of displayable views of process control information representing a process. In particular the HMI application includes a process control data interface for communicating with a source of runtime process information for the set of displayable view. The HMI application also includes a graphical user interface supporting display of a set of faceplate overlays for providing detailed information relating to a control block. Each full-sized faceplate is sized to occupy only a portion of a graphical workstation display. To maintain access to information within the confined space of the faceplate, the faceplate overlay embedded a set of sub-displays within a set of secondary views that are selected via a set of control buttons. Selection of one of the detailed information overlay controls invokes the display of corresponding detailed information within a detailed information pane within the faceplate.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is schematic network diagram showing an exemplary control environment comprising both a control network and an application/supervisory network suitable for carrying out an embodiment of the present invention;

FIG. 2 is a schematic diagram of an HMI application and associated components that execute on a workstation node communicatively coupled to one or more process control data sources that supply process data to the workstation and receive commands from the HMI application;

FIG. 3 is a schematic diagram of the layout for an HMI application display;

FIG. 4 is a schematic diagram depicting the hierarchical arrangement of views of a visualization project;

FIG. 5 is an exemplary overview graphical user interface;

FIG. 6 is an exemplary graphical user interface depicting a set of area view choices for a visualization project;

FIG. 7 is an exemplary graphical user interface depicting a set of group view choices for a visualization project;

FIG. 8 is an exemplary graphical user interface depicting a set of detail view choices for a visualization project;

FIG. 9 is an exemplary graphical user interface depicting a final selection of one of the presented detailed views by a user;

FIG. 10 is a flowchart summarizing a set of steps for generating rows of buttons corresponding to available view choices at levels of a hierarchically arranged set of views of a visualization project;

FIG. 11 is an exemplary HMI application including an exemplary set of control block faceplate overlays;

FIG. 12 is an exemplary user interface for a faceplate overlay including selectable detailed display support;

FIG. 13 is an exemplary user interface for a faceplate overlay including a set of displayed selections for detailed displays and furthermore including detailed information associated with a selected Control detail display;

FIG. 14 is an exemplary user interface for a faceplate overlay including detailed information associated with an Alarms detailed display; and

FIG. 15 is a flowchart summarizing a set of steps for presenting a set of detailed information for a control block via a faceplate overlay including selectable detailed displays.

### DETAILED DESCRIPTION

An HMI application supporting interaction between an operator and runtime control processor information is described herein below by reference to figures illustratively depicting an exemplary embodiment of the invention. In accordance with the illustrative embodiment, the HMI application provides graphical user interface-driven functionality including, among other things supporting a horizontal, persistent, hierarchical view selection menu. Furthermore, visual alarm indicators associated with the view selection menu guide an operator through each view selection level to a view showing an alarm's source. The horizontal view selection menu is traversable by both a graphical pointer and keyboard strokes (e.g., dynamically assigned function keys).

Another aspect of the HMI application user interface comprises a faceplate with detailed overlays. Faceplates are rendered within a portion of the HMI application user interface. In an illustrative embodiment, the faceplates provide access to detailed information from a control block such as alarm limits and tuning parameters. Such detailed information is accessed by first exposing a menu of detailed information, and thereafter rendering the detailed information within a work area of the faceplate separate from the menu from which the detailed information type is selected for the control block. This mode of providing detailed information about a control element enables a user to persist the faceplates within the HMI application 200 window without excessively obscuring a main view area.

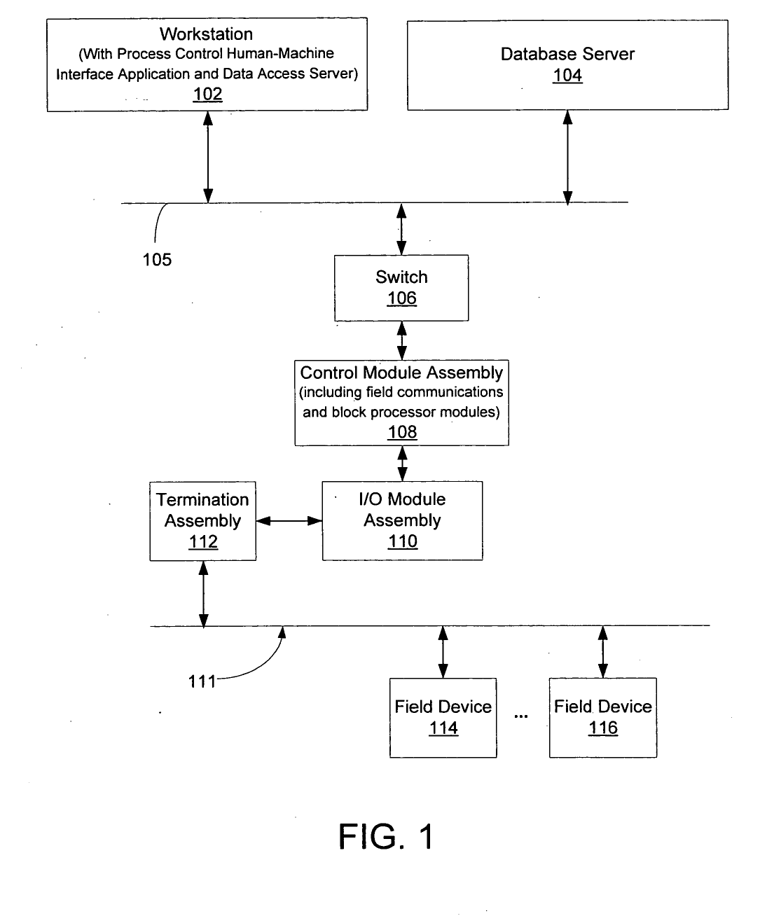

Before, describing a process control system HMI application embodying the present invention, an exemplary process control network environment/facility is briefly described. The present invention is potentially incorporated in a variety of process control facility arrangements, and other physical process control arrangements will be known to those skilled in the art in view of the disclosure contained herein. Turning to FIG. 1, an exemplary simple process control system arrangement/environment is depicted wherein an exemplary HMI application operates to provide visualizations representing process status to an operator. A workstation 102 (e.g., a FOXBORO Application Workstation model AW70P, by Invensys Systems, Inc.), comprising the HMI application and a supporting data access service, provides access to a wide variety of information associated with a process control system. Such information originates, for example, from process sensors and control programs executed on regulatory controllers.

The workstation 102 comprises any of a variety of hardware/operating system platforms. For example, the workstation 102 comprises a personal computer running any of a variety of operating systems such as: Microsoft Windows XP, Unix, Linux, Solaris, Mac OS-X, etc.

In an illustrative embodiment, the HMI application requires very fresh information. To avoid delays due to retrieval from less direct data sources, the workstation 102 receives process data directly from a control module assembly 108 described further herein below. In an exemplary embodiment, a data access server application, to which the HMI application subscribes, receives the process data from the control module assembly 108 on behalf of the HMI application. The HMI application presents a set of views of the controlled process that are driven by the data values retrieved from the control module assembly 108. Alternatively, process control information is retrieved, for example, from a runtime database maintained by a database server 104.

In the illustrative example, the workstation 102 is connected via an Ethernet interface/wiring to an Ethernet switch 106 via a network link 105. Alternatively, a redundant mesh network provides a communicative path between workstations, database servers, and the switch 106. The Ethernet switch 106 can be any of a variety of commercially available switches. By way of example the Ethernet switch 106 is one provided, for example, by Allied Telesyn (e.g., model AT-8088/MT). While not specifically depicted in FIG. 1, additional nodes, comprising workstations, servers and other elements (e.g., high level control module assemblies) of a supervisory portion of the control system are potentially connected to the switch 106.

The switch 106, and potentially other non-depicted switches, is also communicatively coupled to the control module assembly 108. The control module assembly 108 comprises one or more control modules (also referred to as control processors) that execute control programs driven by process sensor data values and render output values to devices (e.g., valves, motors, etc.) controlling a plant process. An illustrative example of such control module is a FOXBORO CP model FCP270, by Invensys Systems, Inc. In other embodiments, process control functionality is carried out in any of a variety of control modules—even by control programs incorporated into the workstations, intelligent transmitters, or virtually any communicatively coupled device capable of executing control programs, loops, scripts, etc.

In an embodiment where the control module assembly 108 is the FOXBORO FCP270, workload is divided, within the FCP270, between controlling data communications and executing control programs (blocks). The FCP270 processes data received from an I/O module assembly 110 in parallel using the two distinct hardware modules—a block processor module and a field communications module. The block processor module repeatedly executes control programs, created by the process control program development facility residing on the workstation 102, according to a relatively long block processing cycle period (e.g., 100 ms). The output values of the control programs executed within the block processor module are driven by process data received by the control module assembly 108 from the I/O module assembly 110. The I/O module assembly 110 comprises, by way of example, INVENSYS FBM207 and/or FBM217 fieldbus modules that pass digital input values to the control module assembly 108. Both the process data and the output values calculated by the control programs on the control module assembly 108 are provided to applications executing on the workstation 102. In an exemplary embodiment, the process data provided by the control module assembly 108 is incorporated into an HMI application providing a set of views supporting interaction between an operator and runtime control processor information.

With regard to the above-mentioned data communications task carried out by the control module assembly 108, in the illustrative example the field communications module within the FCP270 receives data from the I/O module assembly 110. The received data is passed to both the above-mentioned block processor module (within the control module assembly 108) and to process data subscribers (e.g., data access servers such as those running on the workstation 102 and the database server 104) according to an appropriate network communication protocol (e.g., TCP/IP) via the network link 105. The protocols/mechanisms used to provide data to various subscribers varies in accordance with particular embodiments of the invention.

With continued reference to FIG. 1, the I/O module assembly 110, alternatively referred to as a field bus module (FBM), is communicatively coupled to the control module assembly 108. Communications protocols utilized for carrying out communications between the I/O module assembly 110 and control module assembly 108 are potentially any one of a variety of proprietary/non-proprietary communications protocols. In one embodiment, the digital data communications between the control module assembly 108 and I/O module assembly 110 are carried out via a 2 MBit HDLC communication protocol. While only a single I/O module assembly 110 is depicted in the illustrative example, control systems embodying the present invention potentially comprise many I/O module assemblies.

I/O module assemblies, in general, incorporate one or more of a variety of specialized interfaces for communicating directly and/or indirectly to a variety of device types, including sensors/actuators embodying particular communications protocols, located at distributed locations in a plant. In the illustrative example, the I/O module assembly 110 comprises a Foundation Fieldbus I/O module (e.g., an Invensys field bus module model FBM228) that supports communications between the control module assembly 108 and field devices coupled to a Foundation Fieldbus network 111. In the illustrative embodiment, a set of representative intelligent field devices 114 and 116, containing multiple application-dependent configurable parameters, are connected to the Foundation Fieldbus network 111. The field devices 114 and 116 operate at the lowest level of a control system to measure (transmitters) and control (positioners, motor switches, etc.) plant activity. A termination assembly 112 communicatively couples the I/O module assembly 110 to the field devices 114 and 116. The termination assembly 112 provides power and power conditioning to the extent needed by the field devices 114 and 116 on the network 111.

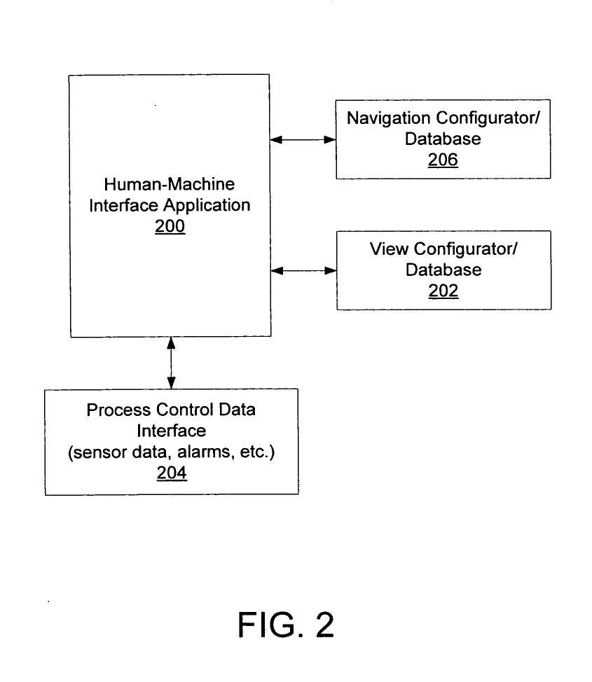

Having described an exemplary network environment within which an HMI application 200 embodying the present invention is potentially incorporated, attention is directed to FIG. 2 that depicts an exemplary set of components associated with the HMI application and their general relationships. A view configurator 202 facilitates creating views, faceplates, and any associated graphical elements contained therein (including specifying any connections between display elements and data sources driving their display state). The configured/defined views are thereafter stored in the View configurator 202's associated database. In an exemplary embodiment, the view hierarchy is configured via a spreadsheet. The spreadsheet information is thereafter used to guide determining the children of each view during operation of the HMI application.

The HMI application 200 also supports sharable/reusable applets and/or components (e.g., Active X controls, Java applets, etc.) within the views. The view configurator 202 also supports modifying the defined views presented by the HMI application 200. The view configurator 202 supports defining a variety of aspects of each view including: display objects (e.g., windows, overlays, popups, etc.), ActiveX controls for alarm viewing, local and remote tags that identify data of interest to the view, scripts and functions associated with buttons, windows, overlays, and the application as whole, and runtime properties. The HMI application 200 interacts with the database of the view configurator 202 to process user requests to present faceplates, windows, and overlays; to process operator requests through button clicks; and to process scripts, display ActiveX controls, etc.

The HMI application 200 receives updates for connected parameters through a process control data interface 204. The interface 204, in turn, communicates with data sources, such as the control module assembly 108, via the network link 105 to obtain process data (e.g., sensor data, alarms, etc.). The process control data interface also supports operator requests to set control parameters, including validating the source of such requests, that are transmitted to a control processor running, for example, on the control module assembly 108.

In embodiments of the invention, alarm reception and initial processing is handled by a separate and distinct alarm sub-system (not shown). An alarm provider receives alarm messages from the control module assembly 108 (control processor), formats the alarm information for the HMI application 200, and sends the alarm information to an alarm subsystem of the HMI application. Thereafter the alarm information is retrieved by alarm consumers on the HMI application 200 operating according to a previously loaded visualization project.

A user, via a navigation configurator 206 and associated database, specifies a navigation tree that defines the hierarchical relationships of the views that make up a visualization project/application for monitoring and executing supervisory control over an associated process. The tree defines parent, child, and (indirectly) sibling relationships among the views defined in the configurator 202's database 202. In an exemplary embodiment, the hierarchy tree supports three levels with twelve buttons at each level. However, the number of supported hierarchical levels (at least two) and the number of buttons at each level differs in alternative embodiments of the invention.

The navigation configurator 206 also supports assigning alarms to particular views of the hierarchy of views for a process visualization project. When an alarm associated with a particular view is set (e.g., a sensor reading is outside a specified range), the particular view is set to an alarm state, resulting in a display state change of a corresponding view button in a horizontal navigation bar 308 (described herein below) and any higher level view buttons through which the view button is reached in a hierarchical arrangement of views. In a particular embodiment, alarms are associated with views at the lowest level of the view navigation hierarchy. When an alarm associated with a particular view is set, the associated button on the horizontal navigation bar 308 flashes in a distinct color (e.g., red). As noted above, the alarm state propagates through each parent view (and associated button on the horizontal navigation bar 308), allowing a user to drill down from an highest level set of views down to the lowest level of views where the alarm originated.

In an exemplary embodiment, the database of the navigation configurator 206, in addition to storing the aforementioned hierarchical relationships, maintains a runtime data structure identifying views that are either labeled “favorites” or most recently used.

The navigation configurator also 206 also includes a report generator enabling a user to establish a report of the view hierarchy for a visualization project and list any user-built views that have not been included in the hierarchy.

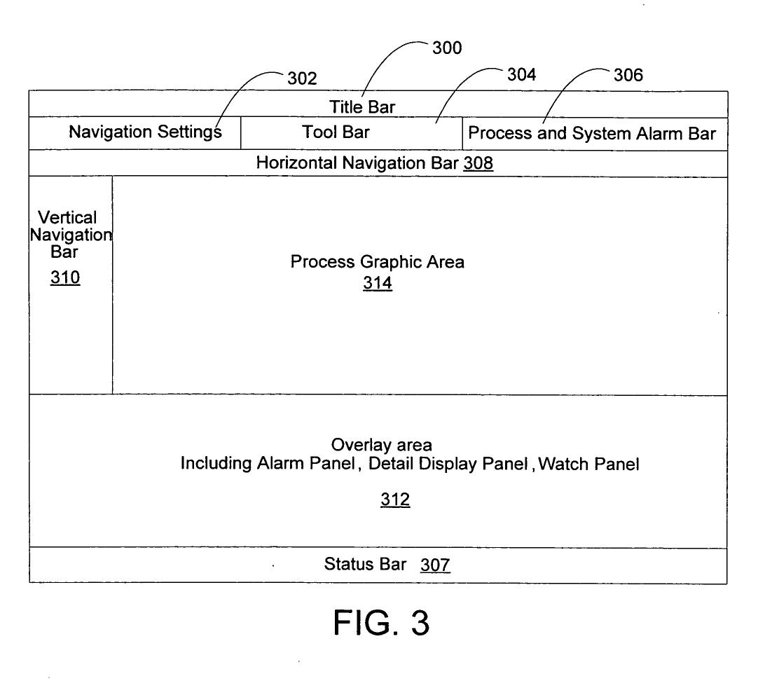

Turning to FIG. 3, an exemplary generalized user interface map is depicted that shows the various locations for various permanent and display on-demand interface components presented by the HMI application 200. The interface comprises a title bar 300 that identifies the HMI application 200 and potentially other information such as a currently loaded visualization project, a current user, etc. A navigation settings area 302 displays a currently selected path through a hierarchy of views of the HMI application 200. A toolbar 304 exposes a set of selectable tools/controls. A process and system alarm bar 306 that displays information relating to any active process or system alarms associated with the currently loaded visualization project. A status bar 307 displays, by way of example, a set of tabs for selecting various ones of a set of on-demand graphical interface components described herein below.

The HMI application 200's user interface includes, by way of example, three on-demand display areas. A horizontal navigation bar area 308 displays a set of user selectable buttons corresponding to available views at various levels of the hierarchy of views supported by a particular loaded visualization project loaded on the HMI application 200. Buttons on the horizontal navigation bar 308 associated with a next lower level in the hierarchy of views are assigned to a particular set of child views in response to selection of one of the buttons representing a view among a set of displayed sibling views. A vertical navigation bar displays the views in the form of expandable/selectable tree having nodes corresponding to the hierarchically arranged views. An overlay area 312 is used to display a variety of user interface components including: an alarm panel, detail display panel and watch panel. A process graphic area 314 that includes the on-demand areas that are shared with the horizontal navigation bar 308, the vertical navigation bar 310, and the overlay area 312 is reserved for displaying the content of the selected views of the visualization project.

Navigating HMI Application Views

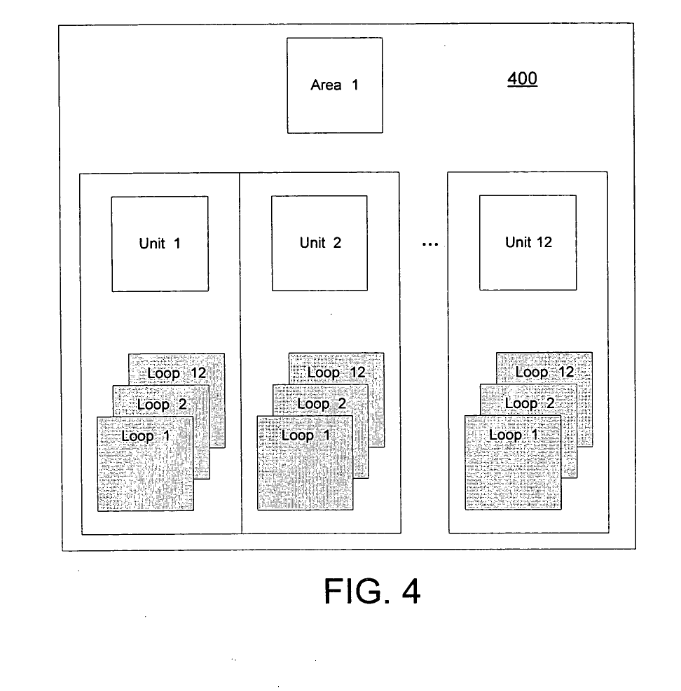

Having described a general environment within which an HMI application operates in accordance with a provided visualization project and associated hierarchically specified views, attention is now directed to navigating the hierarchically specified views in accordance with an illustrative embodiment of the present invention. As noted previously above, the views of a process visualization project are arranged, through the navigation configurator 206, into a hierarchical tree arrangement wherein lower level sets of sibling views present detailed views of particular aspects of a portion of a controlled process represented in a related higher level (parent) view associated with a higher level node in the view selection hierarchy. FIG. 4 schematically depicts the hierarchical relationships between views (represented by appropriately labeled squares such as “Area 1”, “Unit 1”, and “Loop 1”, etc.) within an area 400 designated within a visualization project.

In an exemplary embodiment the display interface of the HMI Application 200 and associated view data structures support visualization project view hierarchies including up to 12 area views at a highest level of the view hierarchy, up to 12 unit views at an intermediate level, and up to 12 loop views at a lowest level. In an exemplary embodiment, the horizontal navigation bar 308 includes at least enough buttons to display each of the available views at each level of the view hierarchy (e.g., an array of buttons comprising 3 rows and 12 buttons per row). In an exemplary embodiment, wherein the (tri-level) horizontal navigation bar 308 supports up to 12 entries (and associated node-specific views) at each of the three levels, allowing for the organization of up to 144 intermediate level unit views and 1728 views at the loop level. However, the number of buttons/supported child views at each level differs in alternative embodiments.

The illustrative display layout depicted in FIG. 3 supports two ways to select a sequence of views while traversing a visualization project's hierarchically arranged views. A first way utilizes a keyboard to traverse the hierarchy of views. In particular, a mapping between up to twelve sibling child views (for a previously selected parent view) and a set of 12 function keys on a keyboard enable a user to traverse the hierarchy using the function keys of a standard full-sized keyboard. In addition, the up, down, left, and right arrow keys can be used to navigate the hierarchical arrangement of the views.

A second way utilizes a graphical (e.g., mouse) pointer to select graphical representations on the horizontal navigation bar 308 and the vertical navigation bar 310. The horizontal navigation bar 308 comprises, by way of example, a three-by-twelve element two-dimensional array of buttons representing up to twelve view choices at each of three hierarchical levels of a view tree for a visualization project. Selecting one of the button fields (corresponding to a view) within a navigation bar opens a view corresponding to the button and populates a next lower level (if available) of the horizontal navigation bar with a set of child views under the selected view. HMI application 200 also supports a version of the horizontal navigation bar 308 wherein only a single level (containing the currently displayed view) is displayed. The single bar style covers less of the view display area than the multiple row version of the horizon navigation bar 308. The vertical navigation bar 310 is similar to a vertically arranged set of nodes in known file directory tree controls. In an exemplary embodiment, all of the above described view hierarchy navigation mechanisms are available to the user at any time.

In addition to the aforementioned view selection modes, the HMI application 200 includes a “Most Recently Used” list, providing direct access to a set of (e.g., 12) most recently accessed views. The HMI application 200 also supports a designated “Favorites” list, providing direct access to a designated set of views in the hierarchy without traversing the view hierarchy of the visualization project. The “Favorites” list is stored according to logged on user.

Turning to FIGS. 5-9, a sequence of screen shots demonstrates a progression of views as a user navigates a multi-level view hierarchy for an oil refinery process control system. FIG. 5 displays a general overview view of the visualization project. The horizontal navigation bar 308 has not yet been displayed. This view is not generally part of the view hierarchy for the visualization project. Rather, it is an entry point for accessing one or more area views for the visualization project. However, process and system alarms (most recent, unacknowledged) are displayed in alarms field 500 in the overview display. In response to an alarm notification in the alarms field 500 (e.g., Process alarm is in an alarm state), it is contemplated that if not already displayed, an operator selects a navigate button 502 (or any other suitable control) to generate the horizontal navigation bar 308 to access a detailed view corresponding to the source of the alarm.

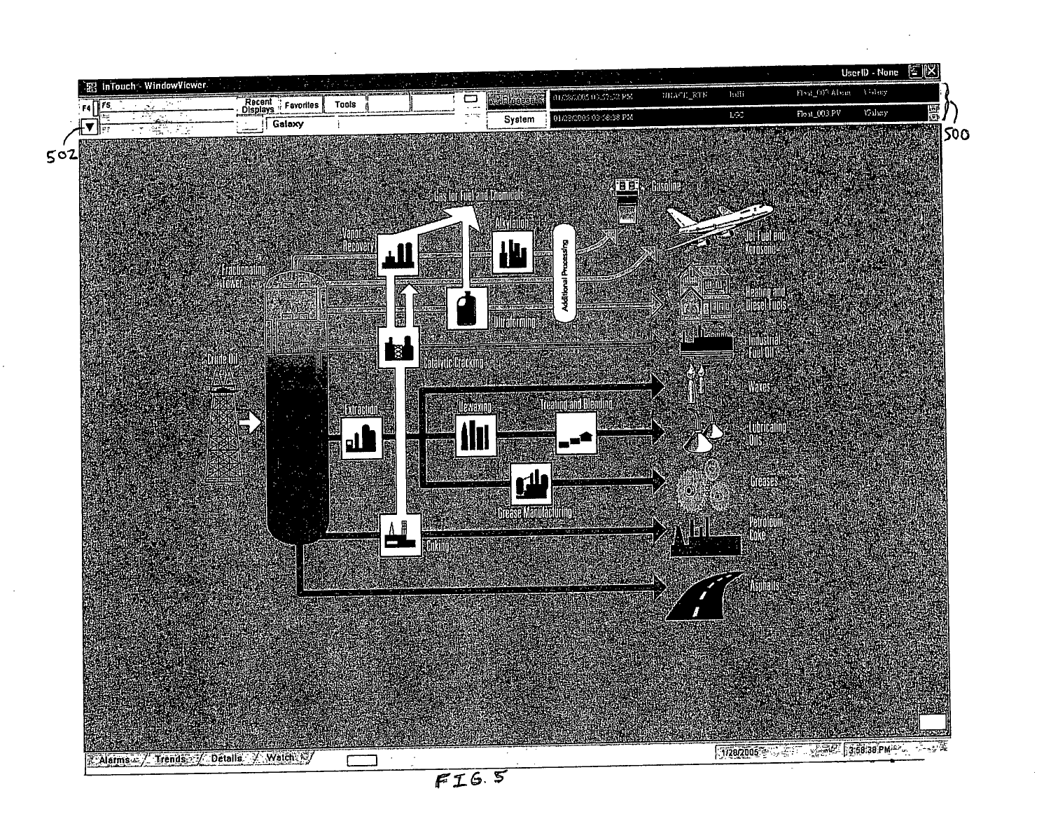

Turning to FIG. 6, in response to a user selecting the navigate button 502, a set of area buttons (e.g., Gasoline, Jet Fuel, and Heating Fuel) are labeled in row 600 of a horizontal navigation bar 608 to indicate their relationships to particular area views of a visualization project for the oil refinery. The Jet Fuel button in row 600 indicates that the Jet Fuel area is in alarm.

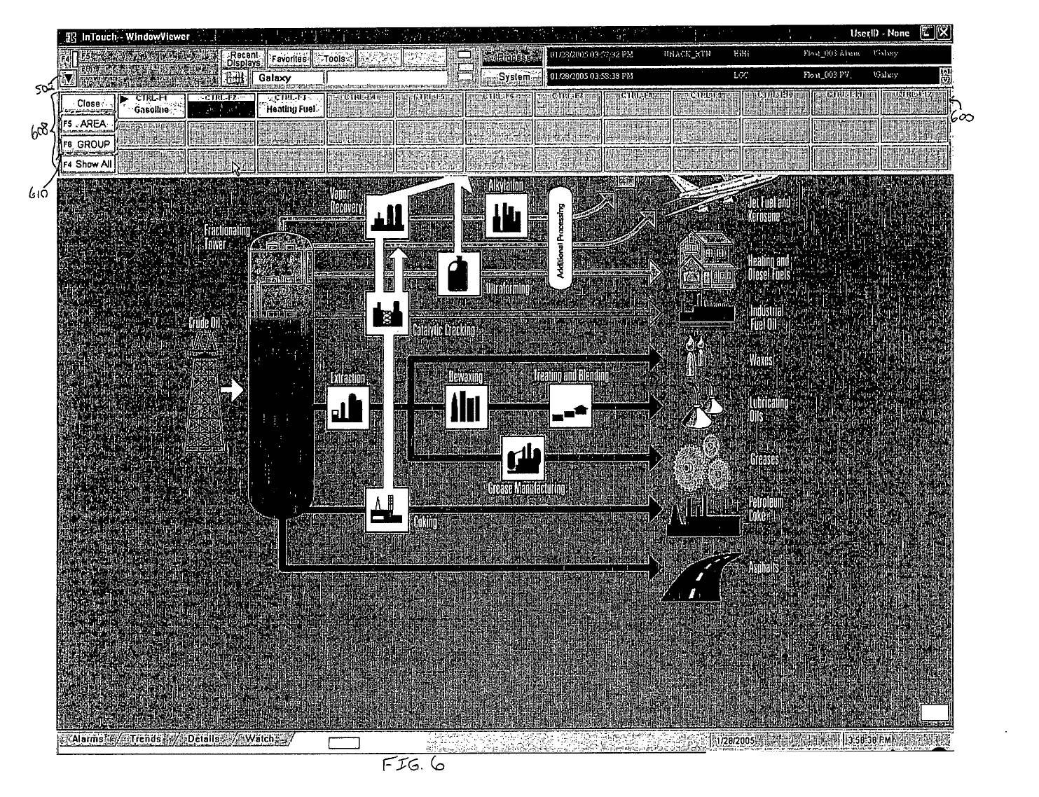

In an exemplary embodiment, each selectable button in the hierarchy is associated with a corresponding view and potentially own alarms associated with the view. However, only a view at the lowest level of the hierarchy of views is automatically displayed within the process graphic area 314 in response to a user's selection of a corresponding button on the navigation bar 608. Therefore, in the illustrative embodiment, a set of buttons 610 labeled “Area” and “Group” are provided that enable a user to request the HMI application 200 to display a view corresponding to a presently registered selection at either of the top two selection rows (e.g., the Areas and Groups) within the three-level horizontal navigation bar 608. In an alternative embodiment, the HMI application 200 automatically commences presenting a view associated with a selected button in the horizontal navigation bar 308. Turning to FIG. 7, after selecting the Jet Fuel button in row 600, the view associated with the Jet Fuel area is displayed. An updated horizontal navigation bar 708 includes a group row 700 that depicts a set of group view buttons (e.g., Fractionator, HydroCracker, and HydroTreater) corresponding to a set of views that are children of the selected Jet Fuel area view. The updated horizontal navigation bar 708 continues to display the areas in row 600. The Fractionator button in the group row 700 shows that the Fractionator group of the Jet Fuel area is in alarm.

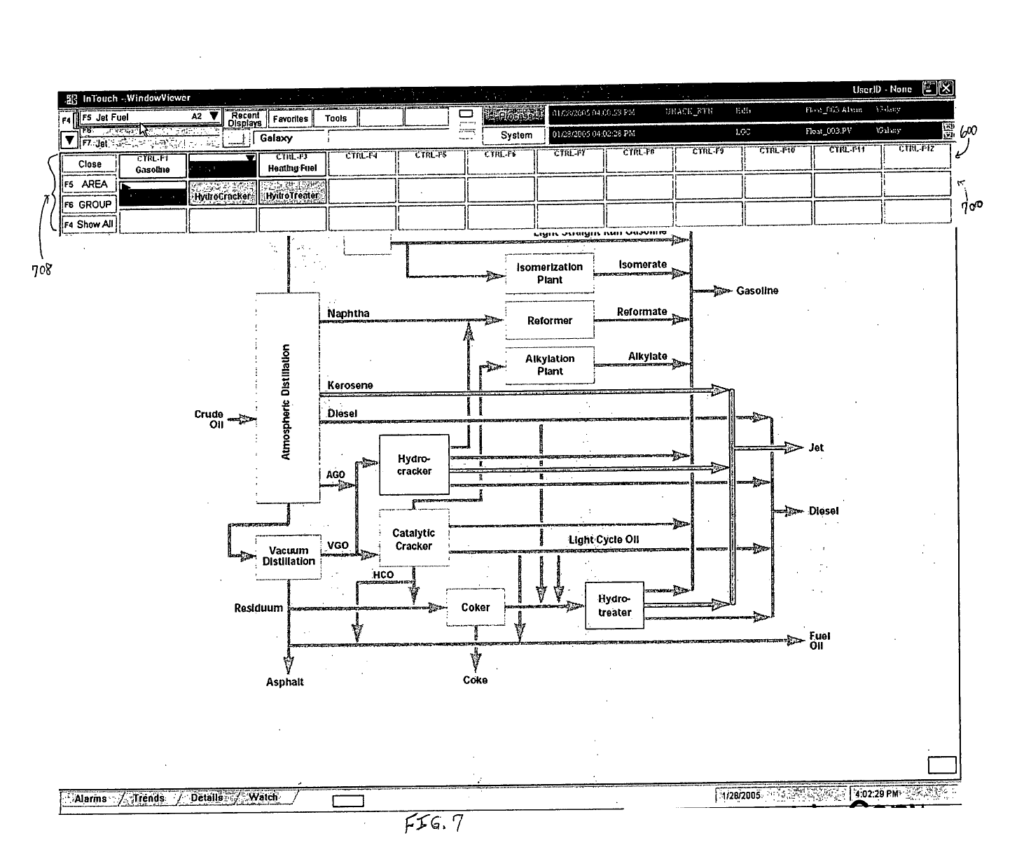

Turning to FIG. 8, after selecting the Fractionator button in the group row 700, the view associated with the Fractionator group is displayed. An updated horizontal navigation bar 808 includes a set of detailed view buttons (e.g., Bottoms, Reactor, Flare, Feed, Steam, LCO Stripper, HCO Stripper, etc.) corresponding to a set of view that are children of the selected Fractionator group view. The updated horizontal navigation bar 808 continues to display the areas in row 600 and the groups (under the selected Jet Fuel area) in row 700. The LCO Stripper button in row 800 indicates that the LCO Stripper is in alarm. In the illustrative embodiment, row 800 represents the lowest level of the view selection hierarchy. However, alternative embodiments include additional view hierarch levels.

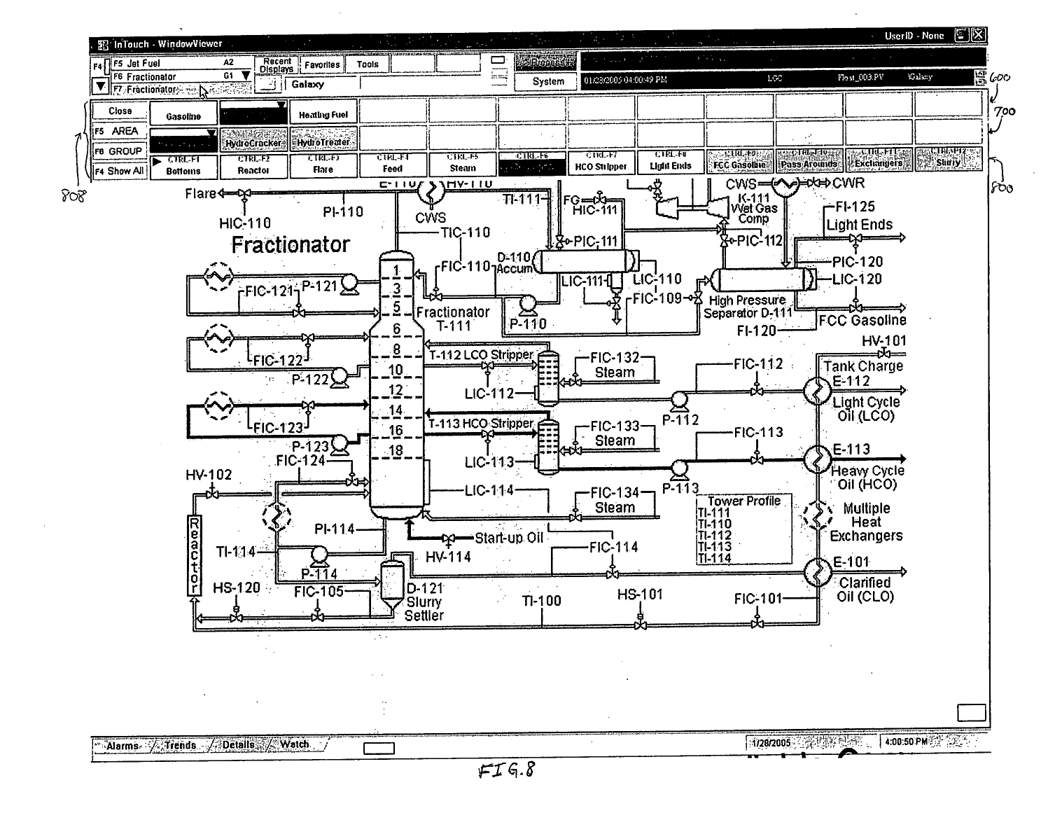

Turning to FIG. 9, after selecting the LCO Stripper button in row 800, the view associate with the LCO Stripper is displayed. Since row 800 represents the lowest level of the view hierarchy in this particular example, selecting the LCO Stripper button in row 800 does not generate another set of selections corresponding to child views of the LCO Stripper view depicted in FIG. 9. An updated horizontal navigation bar 908 includes three levels of view options as well as an indicator mark within each previously selected button to indicate the set of selections made by an operator to reach the depicted LCO Stripper view.

It is noted that in addition to the above-described horizontal navigation bar, the system supports selection of particular views, without displaying the horizontal navigation bar 308, by selecting particular keys on a keyboard (e.g., Control+Function #) to traverse down the view hierarchy to an intended view.

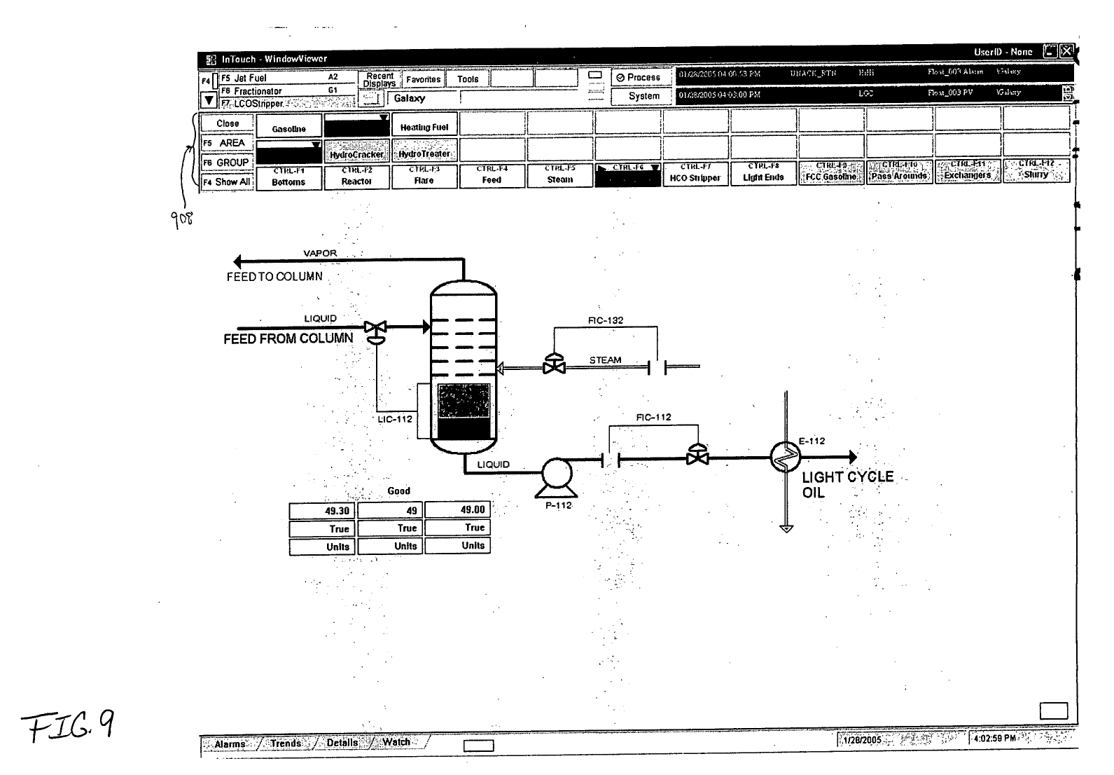

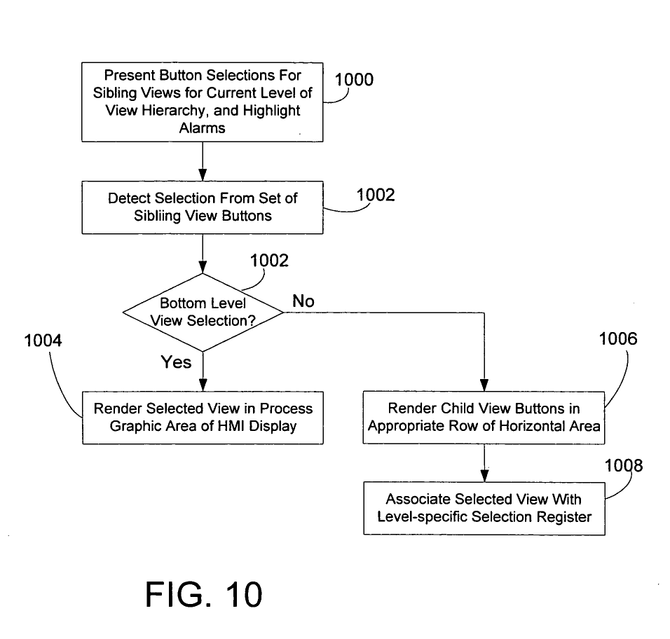

Having described an exemplary user interface for the HMI application 200 incorporating a horizontal navigation bar for traversing a set of hierarchically arranged views of a visualization project, attention is directed to FIG. 10, that depicts a flowchart summarizing a general set of steps for providing access to a set of hierarchically arranged views of a visualization project via a set of horizontally arranged navigation bars (e.g., the horizontal navigation bar 308). Initially, during step 1000, the HMI application 200 identifies a set of sibling views within a horizontal row of buttons for a current level of the view hierarchy. If a user has not previously made a selection, then the current level is the top level (e.g., the area) of the view hierarchy. The buttons are modified, if needed, to indicate an associated alarm.

At step 1002, the HMI application 200 detects a user's selection of one of the sibling views. In response, during step 1004 if the selection is of a view at the bottom of the view hierarchy for the visualization project, then control passes to step 1004. At step 1004 the HMI application 200 acquires a view corresponding to the user's selection and renders the selected view in the process graphic area 314.

Otherwise, if the selection does not correspond to a bottom level view, then control passes to step 1006 wherein the HMI application 200 displays a set of child view buttons, for the selected parent view, within a next lower level on the horizontal navigation bar 308. At step 1008, that may alternatively be performed before step 1006, the HMI application 200 associates the view corresponding to the button detected during step 1002 with an appropriate one of the view register buttons 610 (e.g., Area and Group). The registration of the view enables a user to request display of the view by selecting the button.

The above-described exemplary steps correspond to presenting a set of buttons representing sibling views in a current row, and then processing an operator's selection of one of the siblings. The process summarized in FIG. 10 is repeated until a user has either arrived at a view of interest or at a lowest level of the hierarchical tree for a set of views within the visualization project.

Faceplates For Accessing/Displaying Detailed Block Information

Another aspect of the HMI application 200 that provides for an enhanced user experience is the presence of faceplates including detailed display of control block information. The faceplates are generated as graphics (potentially complex data-driven animated displays) that are thereafter associated with a control block executed by a control processor in a runtime process control environment. Faceplates are small views of the control block information. Because of their reduced size, a number of faceplate overlays can be displayed on the screen at one time. However, they also have less area to present information than known full size detail display interfaces for control block information.

The faceplates are called into the HMI application 200's display in any of a number of ways. A control block corresponding to the information of interest is specified by, for example: entering the control block name in a data entry field on the HMI application's user interface; selecting an updating field within a faceplate, or process graphic; or selecting a previously selected control block from a drop down list of the previously accessed control blocks. After a control block has been selected, a user opens a Faceplate Location Dialog by selecting a Faceplate button on a toolbar of the HMI application 200. From the Faceplate Location Dialog, the user selects a location for displaying the faceplate for the selected control block.

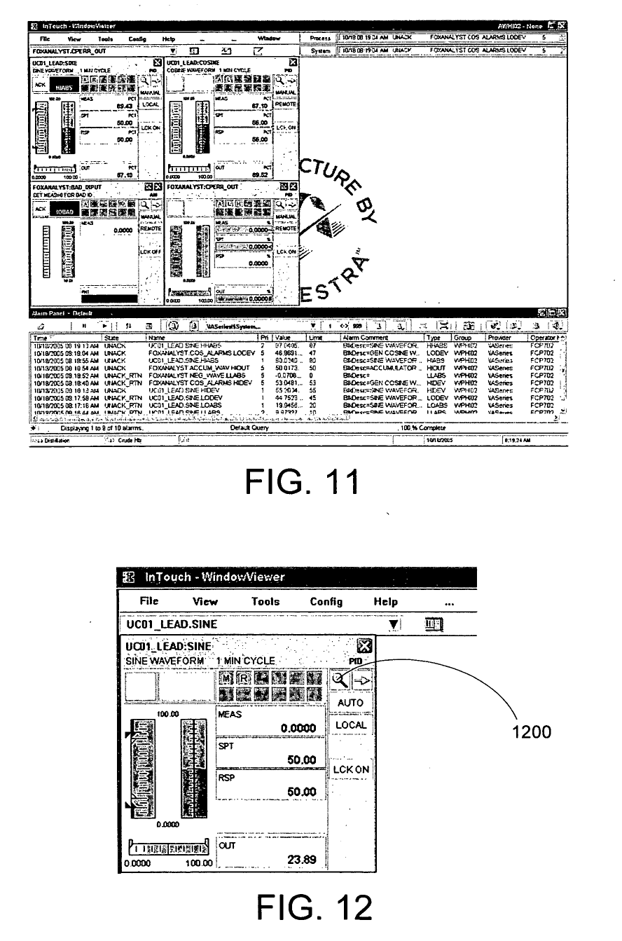

After the faceplate location is selected, a faceplate overlay for a selected control block is displayed in the selected location. The type of faceplate overlay is based on the type of block selected. FIG. 11 depicts a set of four faceplate overlays (and an alarm window) within a parent window of the HMI application 200. Because of their relatively compact size, it is possible for at least eight faceplate overlays to be simultaneously displayed without overlap on a single screen.

The relatively compact size generally limits the information provided by the faceplate overlay for a selected control block. However, in accordance with an aspect of the exemplary embodiment of the HMI application 200, detailed information is selectively displayed from an initially hidden menu of detailed information overlays. Turning to FIG. 12, an example of an initial PID faceplate overlay is illustratively depicted within a top-left corner of a workspace of the HMI application 200's display. Primary information for an associated PID control block is displayed on the first page of the faceplate overlay. However, the overlay contains additional detail overlays showing more information, (e.g., MEAS, SPT, OUT, BLKSTA, Alarms). The additional information provided by each detail overlay is accessed using a multi-step selection process for selectively displaying information associated with a previously selected control block. With continued reference to FIG. 12, a user selects a magnifying glass button 1200 within a displayed faceplate overlay.

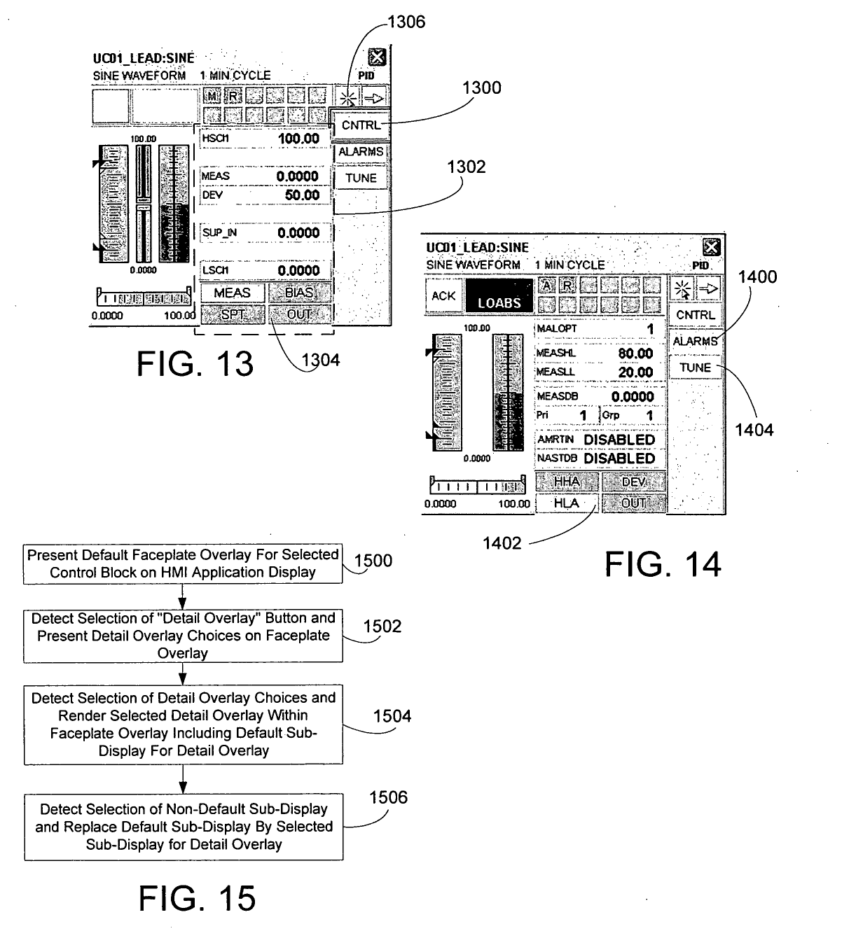

Turning to FIG. 13, in response to the user's selection of the button 1200 (control element), a set of buttons on the right side of the faceplate overlay are replaced by a set of choices for detailed information overlays (e.g., Control, Alarms, Tune). The detailed information and controls associated with the detailed information overlays is displayed within a detailed information pane 1302 that occupies only a portion of the total area of the faceplate. A variety of alternative controls can be used instead of the button 1200 such as tabs, icons, etc. In the example, a CNTRL button 1300 has been selected to access detailed control information associated with the PID control block. The selectable detailed information overlays enable displaying particular control block information within a relatively compact area on a display.

The exemplary embodiment supports further dividing a top-level detailed display into sub-displays. For example, in the illustrative embodiment, the information associated with the CNTRL detailed information overlay has been further divided into four sub-displays that are accessed via a set of sub-display buttons 1304 (i.e., MEAS, SPT, BIAS and OUT) within the detailed information pane 1302. The arrangement for providing sub-displays differs from the above-described hierarchical arrangement of views within a visualization project since there is no generalized “detailed information display” associated with the selection of the CNTRL button 1300. Instead, a default sub-display of the four sub-displays is rendered (e.g., MEAS).

The MEAS sub-display button has been selected in the illustrative example in FIG. 13. A set of control measurement parameter labels and current values are displayed in a portion of the detailed information pane 1302 above the sub-display buttons—replacing a set of parameters and associated current values displayed for the generalized PID interface of FIG. 12. Selecting other ones of the sub-display buttons 1304, i.e. BIAS, SPT, OUT, causes an appropriate sub-display to be rendered in the area 1302.

A user hides a selected detailed information overlay by selecting one of the detailed information overlay buttons (CNTRL, ALARMS, and TUNE) rendered on the right side of the faceplate overlay. Selecting the active CNTRL button 1300 deselects the previous selection and returns the detailed information pane 1302 to its initial state (depicted in FIG. 12). Selecting the detailed information button 1306 hides the detailed display buttons (e.g., CNTRL, ALARMS, and TUNE).

Turning briefly to FIG. 14, an exemplary detailed information overlay is depicted when a user selects an ALARMS detailed information overlay button 1400 and an HLA button from a set of alarm sub-display buttons 1402. A similar layout arrangement is provided when the Tune button 1404 is selected for a detailed information overlay within the faceplate overlay of the PID block.

Turning to FIG. 15, a set of steps summarize the process of presenting detailed information for a control block within an associated faceplate overlay. During step 1500, a default faceplate overlay is displayed for a selected control block (identified by a unique compound and block combination). Thereafter, at step 1502 a user's selection of the detail button 1200 for revealing a set of choices for detailed information associated with the selected control block is detected. In response, the HMI application 200 identifies and presents (e.g., as a set of buttons) a set of choices for detailed information overlays within the display space of the default faceplate overlay. In the illustrative embodiment (see, e.g., FIG. 13) the choices for detailed information overlays are rendered along a right side of a faceplate overlay.

At step 1504, in response to a user's selection of one of the displayed detailed information overlay choices (e.g., CNTRL), the HMI application 200 replaces a portion of the faceplate overlay (e.g., the region occupied by pane 1302) with the selected detailed information overlay. The exemplary embodiment of the detailed information overlays, depicted in FIG. 13, further provides a set of sub-display buttons for providing even more information within the limited space of the faceplate overlay. Initially, however, a default sub-display (e.g., MEAS) is rendered during step 1504.

During step 1506, in response to the user's selection of one of the non-default sub-display buttons (e.g., BIAS in FIG. 13), the default sub-display is replaced by a sub-display corresponding to the user's sub-display choice.

It is noted that the above set of graphical user interfaces and summarized steps for providing control block details in the form of a set of selectable detail overlays displayed within a faceplate overlay are merely exemplary. Those skilled in the art will appreciate, in view of the disclosure herein, that there are a variety of ways to present choices, within a faceplate for a control block.

The structures, techniques, user interfaces and associated benefits discussed above are merely exemplary embodiments of the invention. The exemplary interfaces, including the faceplates are carried out by software, stored on computer-readable media in the form of computer executable instructions. In view of the many possible embodiments to which the principles of this invention may be applied, it should be recognized that the embodiments described herein with respect to the drawing figures are meant to be illustrative only and should not be taken as limiting the scope of invention. The illustrated embodiments can be modified in arrangement and detail without departing from the spirit of the invention. Moreover, those of skill in the art will recognize that the disclosed principles are not limited to any particular local area network protocols and/or topologies. Therefore, the invention as described herein contemplates all such embodiments as may come within the scope of the following claims and equivalents thereof.

What is claimed is:

1. A human machine interface (HMI) application for executing a visualization project for a process control system, wherein the visualization project comprises a set of displayable views of process control information, the HMI application comprising:
a process control data interface for communicating with a source of runtime process information for the set of displayable view; and
a graphical user interface supporting display of a set of faceplate overlays for providing detailed information relating to a control block, wherein each full-sized faceplate overlay occupies a portion of a graphical workstation display and each faceplate overlay comprises:
a set of detailed information overlay controls and wherein selection of one of the detailed information overlay controls displays corresponding detailed information within a detailed information pane.

2. The HMI application of claim 1 wherein each faceplate includes a detailed information access control that, when selected, displays the set of detailed information overlay controls within the faceplate overlay.

3. The HMI application of claim 1 wherein the set of detailed information overlay controls comprises a set of button controls.

4. The HMI application of claim 1 wherein a selected detailed information overlay displayed within the detailed information pane includes a set of sub-display buttons corresponding to a set of displayable subsets of information associated with the selected detailed information overlay.

5. The HMI application of claim 1 wherein the faceplate displays information relating to a PID control block.

6. The HMI application of claim 1 wherein the detailed information associated with one of the detailed information overlay controls comprises alarm limits.

7. The HMI application of claim 1 wherein the detailed information associated with one of the detailed information overlay controls comprises tuning parameters.

8. The HMI application of claim 1 wherein the detailed information associated with one of the detailed information overlay controls comprises control parameters.

9. The HMI application of claim 1 wherein each full-sized faceplate overlay occupies a minority of a graphical workstation display area.
